(19) United States
(12) Patent Application Publication
(10) Pub. No.: US 2007/0284942 A1
(43) Pub. Date: Dec. 13, 2007

(54) Method for Data Security in Vehicle Components and Corresponding Vehicle Component

(75) Inventors: Frank Cornelius, Stuttgart (DE); Andreas Mueller, Holzgerlingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/547,087

(22) PCT Filed: Mar. 22, 2005
(86) PCT No.: PCT/EP05/03021

§ 371 Date: Sep. 29, 2006

(30) Foreign Application Priority Data
Apr. 2, 2004 (DE) 10 2004 016 289.1

(51) Int. Cl. B60R 25/00

(52) U.S. Cl. 307/10.2

(57) ABSTRACT

An apparatus and method for data security for a vehicle component in which security data is stored in the vehicle component are provided. Security data which is present in the vehicle component is stored in the vehicle component after having been encrypted by an encryption method and, when necessary, is decrypted by a decryption method and stored again after use having been encrypted again by the encryption method.

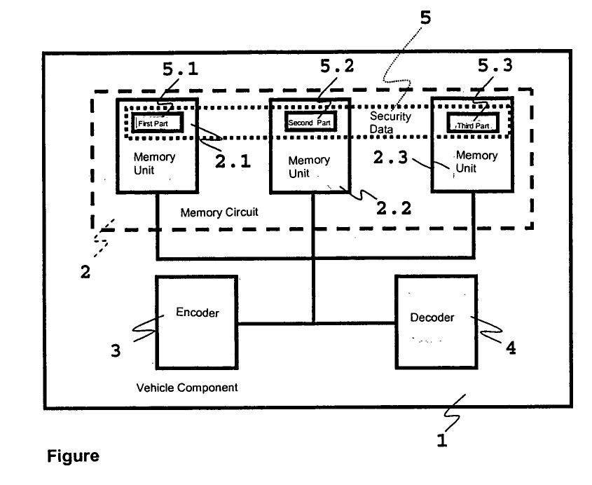

### CROSS REFERENCE TO RELATED APPLICATIONS

This application is a national stage of PCT International Application No. PCT/EP2005/003021, filed Mar. 22, 2005, which claims priority under 35 U.S.C. § 119 to German Patent Application No. 10 2004 016 289.1 filed Apr. 2, 2004, the entire disclosures of which are herein expressly incorporated by reference.

### BACKGROUND AND SUMMARY OF THE INVENTION

The present invention relates to a method for data security in vehicle components.

For satisfactory operation of vehicle components, vehicle data is programmed into the vehicle components by corresponding methods and devices. The vehicle components may be, for example, electronic control units, electronic keys, vehicle antitheft systems, etc. Secret data, which is part of a vehicle antitheft system, is of particular interest in these components. The term vehicle component is to be understood here in a broad sense, meaning that it includes not only components which are permanently installed in the vehicle but also other vehicle-related components, such as vehicle keys.

German patent document DE 195 32 067 C1 describes a method and a device for programming operating data into vehicle components. In the described method, vehicle-related data, which is also referred to below as vehicle data, is encoded with an individual code word and transmitted in encrypted form into the vehicle component. The individual code word for each vehicle component, into which vehicle-related data can be programmed, is stored in a database. Similarly, the same secret code word is stored in each of the vehicle components during production of respective vehicle components when a symmetrical coding method is used. Alternatively, an assigned secret code word is stored in each of the vehicle components when an asymmetric coding method is used.

By using the described method, the vehicle data is actually decrypted in the vehicle component itself so that the vehicle data does not appear in an open, i.e., decoded form, at any point during the transmission. Instead, the vehicle-related data is encoded with the secret, individual code word over the entire transmission path between a transmitting point and the vehicle component. This provides very reliable protection against unauthorized attempts to carry out unauthorized programming of other vehicle components by virtue of knowledge of this vehicle-related data.

One object of the invention is to increase further the data security of vehicle components, such as theft-related vehicle components.

This and other objects and advantages are achieved by a method for data security for vehicle components and a vehicle component.

According to the invention, security data which is present in a vehicle component is stored after having been encrypted by an encryption method. The security data is decrypted by a decryption method, when necessary. After using the decrypted security data, it is encrypted again by the encryption method and stored. This ensures that data which is to be kept secret is not stored in a decoded form in the vehicle component, i.e., it is stored in an encrypted form and cannot be read out by unauthorized persons by tampering. The method according to the invention is applied for every reading and writing operation in which an associated memory circuit is accessed. As a result of the method according to the invention, it is no longer necessary to distinguish between a spare vehicle component and a series produced vehicle component since the same method for programming in the vehicle data such as is described German patent document in DE 195 32 067 C1, for example, can be applied for both types of vehicle component. As a result, costs can be reduced for development and for production.

In a refinement of the method according to the invention, the security data which is stored in the vehicle component comprises a secret code word for decrypting the vehicle data which is transmitted in encrypted form and/or a vehicle component status which may specify whether or not the vehicle component is already integrated completely into a vehicle system. This advantageously prevents an unauthorized person from tampering with the status of the vehicle component in such a way that the vehicle component assumes a status in which it can be newly programmed and can thus be integrated into a new vehicle environment, such as into a stolen vehicle.

In a further refinement of the method, the security data is stored in encrypted form in the vehicle component when the vehicle component is manufactured.

In order to increase further the data security, in one exemplary embodiment of the method according to the invention, the security data is divided into a plurality of parts which are stored at different locations in the vehicle component.

At least a first part of the security data is, for example, made identical for a group of vehicle components.

At least a second part of the security data is, for example, made individual for each vehicle component within the group of vehicle components.

The first and/or the second and/or the third part of the security data are stored, for example, as software in a first memory unit, in particular in a flash block of the vehicle component.

The first and/or the second and/or the third part of the security data is stored, for example, as a ROM mask in a second memory unit in the vehicle component.

The first and/or the second and/or the third part of the security data is stored, for example, in particular in an EEPROM in a third non-volatile memory unit in the vehicle component.

In order to carry out the method according to the invention, a vehicle component includes a memory circuit in which security data may be stored. The security data which may be transmitted with vehicle data in encrypted form can be decrypted. The vehicle component may also include an encoder which stores the security data present in the vehicle component in the memory circuit in encrypted form. The vehicle component may further include a decoder which decrypts the stored security data when necessary.

In one refinement of the vehicle component, the memory circuit of the vehicle component comprises a plurality of memory units, the security data being divided into a plurality of parts which are stored in various memory units of the memory circuit.

Other objects, advantages and novel features of the present invention will become apparent from the following detailed description of the invention when considered in conjunction with the accompanying drawings.

### BRIEF DESCRIPTION OF THE DRAWING FIGURES

The FIGURE shows a block circuit diagram of a vehicle component for carrying out the method according to the invention.

### DETAILED DESCRIPTION OF THE DRAWINGS

As is apparent from the FIGURE, a vehicle component 1 for carrying out the method for data security for vehicle components 1 may comprise a memory circuit 2 (illustrated by dashed lines) in which security data 5 (illustrated by dashed lines) is stored, an encoder 3 which encrypts the security data 5 which is present in the vehicle component 1 and stores it in the memory circuit 2, and a decoder 4 which decrypts the stored security data 5 when necessary.

As is also apparent from the FIGURE, the memory circuit 2 may comprise a plurality of memory units 2.1, 2.2, 2.3, in each of which part 5.1, 5.2, 5.3 of the security data 5 which is divided into a plurality of parts 5.1, 5.2, 5.3 is stored.

The security data 5 which is stored in encrypted form in the memory units 2.1, 2.2, 2.3 of the memory circuit 2 makes available, for example, a secret code word which is necessary in order to decrypt vehicle data which has been transmitted in encrypted form to the vehicle component 1. In addition, the security data 5 can also comprise the vehicle component status which specifies, for example, whether the vehicle component 1 is already programmed and activated, i.e., integrated into an existing vehicle system, or whether it is not yet completely programmed and activated.

The security data 5 is, for example, introduced into the vehicle component 1 during production and encoded by the encryption method implemented in the vehicle component 1, and stored after having been distributed among the individual memory units 2.1, 2.2, 2.3 in the memory circuit 2. The vehicle component status indicates at this time that the vehicle component 1 has not yet been integrated into an existing vehicle system. If the vehicle component 1 is integrated into a corresponding vehicle system during the production of the vehicle by programming the vehicle component 1 with the associated vehicle data, this is indicated by the updated vehicle status which, as has already been explained, is part of the security data 5.

In order to update the vehicle status, the stored security data 5 is read out of the memory circuit 2 and decoded by the decoder 4. The decoded, i.e., decrypted, security data 5 which comprises the secret code word and the vehicle component status, is subsequently used to decrypt the vehicle data which has been received in encrypted form, and to store it in associated memory units 2.1, 2.2, 2.3 of the memory unit 2. The vehicle component status is then updated, i.e., the updated vehicle component status now indicates that the vehicle component 1 is integrated into a vehicle system. The security data 5 is stored, after having been encrypted again by the encoder 3, in the memory unit 2. In particular, the security data is stored after having been distributed among the memory units 2.1, 2.2, 2.3. The encrypted storage of the security data 5 makes it virtually impossible for an unauthorized person to tamper with the security data 5 stored in the vehicle component 1 and change the current vehicle component status or read out the secret code word from the vehicle component 1.

In the illustrated exemplary embodiment, the first memory unit 2.1 is embodied, for example, as a flash memory block in which the first part 5.1 of the security data 5 is stored as software data. In alternative embodiments it is also possible for the second and/or the third part 5.2, 5.3 of the security data 5 to be stored in the first memory unit 2.1.

In the illustrated exemplary embodiment, the second memory unit 2.2 is embodied, for example, as a ROM memory module in which the second part 5.2 of the security data 5 is stored as a ROM mask. In alternative embodiments, the first and/or the third parts 5.1, 5.3 of the security data 5 can also be stored in the second memory unit 2.2.

In the illustrated exemplary embodiment, the third memory unit 2.2 is embodied, for example, as a non-volatile memory unit 2.3, in particular as an EEPROM in which the third part 5.3 of the security data 5 is stored as software data. In alternative embodiments, the first and/or the second part 5.1, 5.2 of the security data 5 can also be stored in the third memory unit 2.3.

In the illustrated exemplary embodiment, the first part 5.1 of the security data 5 may be made identical for a group of vehicle components 1, for example for all the engine control units.

The second part 5.2 of the security data 5 can be made identical for a specific group of vehicle components, for example, all the engine control units with a specific version of software.

The third part 5.3 of the security data 5 can be made individual for each vehicle component. Of course, the first and/or the second parts 5.1, 5.2 of the security data 5 can also be made individual.

The inventive encrypted storage of the security data which is present in a vehicle component and the decryption, when necessary, of the security data which is stored in encrypted form further increases the data security in the vehicle components, in particular in theft-related vehicle components.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A method for data security for a vehicle component, in which security data, for decrypting vehicle data transmitted in encrypted form, is stored in the vehicle component, the method comprising:
encrypting the security data; and
storing the encrypted security data in the vehicle component;
for decrypting vehicle data that is in encrypted form, decrypting the security data; and
after use of decrypted security data to decrypt the vehicle data, encrypting and storing the security data once again.

13. The method as claimed in claim 12, wherein the security data comprises a secret code word or a vehicle component status.

14. The method as claimed in claim 12, wherein the security data is stored in the vehicle component when the vehicle component is manufactured.

15. The method as claimed in claim 12, wherein the security data comprises a plurality of parts which are stored at different locations in the vehicle component.

16. The method as claimed in claim 15, wherein at least a first part of the security data is made identical for a group of vehicle components.

17. The method as claimed in claim 15, wherein at least a second part of the security data is made unique for each vehicle component within the group of vehicle components.

18. The method as claimed in claim 15, wherein the first or the second or the third part of the security data is stored as software data in a first memory unit in a flash block of the vehicle component.

19. The method according to claim 15, wherein the first or the second or the third part of the security data is stored as a ROM mask in a second memory unit in the vehicle component.

20. The method as claimed in claim 15, wherein the first or the second or the third part of the security data is stored in a third, non-volatile memory unit in the vehicle component which comprises an EEPROM.

21. The method as claimed in claim 13, wherein the security data is stored in the vehicle component when the vehicle component is manufactured.

22. The method as claimed in claim 13, wherein the security data comprises a plurality of parts which are stored at different locations in the vehicle component.

23. The method as claimed in claim 14, wherein the security data comprises a plurality of parts which are stored at different locations in the vehicle component.

24. The method as claimed in claim 22, wherein at least a first part of the security data is made identical for a group of vehicle components.

25. The method as claimed in claim 23, wherein at least a first part of the security data is made identical for a group of vehicle components.

26. The method as claimed in claim 16, wherein at least a second part of the security data is made unique for each vehicle component within the group of vehicle components.

27. The method as claimed in claim 16, wherein the first or the second or the third part of the security data is stored as software data in a first memory unit in a flash block of the vehicle component.

28. The method according to claim 16, wherein the first or the second or the third part of the security data is stored as a ROM mask in a second memory unit in the vehicle component.

29. The method as claimed in claim 16, wherein the first or the second or the third part of the security data is stored in a third, non-volatile memory unit in the vehicle component which comprises an EEPROM.

30. A vehicle component comprising:
a memory circuit configured to store security data with which vehicle data which has been transmitted in encrypted form can be decrypted;
an encoder which stores the security data which is present in the vehicle component in encrypted form in the memory circuit; and
a decoder configured to decrypt the stored security data.

31. The vehicle component as claimed in claim 30, wherein the memory circuit comprises a plurality of memory units and the security data is divided into a plurality of parts which are stored in the plurality of memory units of the memory circuit.
